(19) United States
(12) Patent Application Publication
(10) Pub. No.: US 2006/0129269 A1
(43) Pub. Date: Jun. 15, 2006

(54) Processes for using a memory storage device in conjunction with tooling

(75) Inventors: Erin L. Conner, Rochester, NY (US); James A. Pascucci, Williamson, NY (US)

Correspondence Address: OLIFF & BERRIDGE, PLC., P.O. BOX 19928, ALEXANDRIA, VA, 22320, US

(73) Assignee: Xerox Corporation

(21) Appl. No.: 11/012,805

(22) Filed: Dec. 15, 2004

(51) Int. Cl. G06F 19/00

(52) U.S. Cl. 700/175; 700/179

(57) ABSTRACT

A process for using a data memory device in conjunction with an item of tooling such as an injection mold wherein the tooling is fixedly coupled with a memory device for storing information such as tool identification information, optimal and actual operating parameters, cycle count, and similar information useful for the tracking, use, maintenance, and repair of the tooling.

### BACKGROUND AND SUMMARY

This application relates generally to an apparatus and method for tracking the usage and operating conditions of tooling parts in general and more particularly to industrial tooling.

One characteristic of modern efficient manufacturing is the contract manufacturing by vendors of many components and subassemblies of larger systems. For most large companies, such sub-contracting lowers costs and enables vendors with specialized equipment and expertise to make the components and subassemblies more efficiently and with less overhead. Engineering and design services by vendors are also often provided in conjunction with or as a substitutes for engineering design services by the manufacturer of the larger system.

In many instances, components designed for specific applications are unique and require unique tooling for their manufacture. Such unique tooling can comprise dies, stamps, molds, fixtures, jigs, patterns, specialized cutting and drilling tools, and any of a wide number of other devices and components that are dedicated for the use of a specific customer or component. For purposes of this specification and claims, “tooling” and “tools” shall mean any of the above and similar devices and components that are used primarily in the manufacture of other components, subassemblies, or devices rather than having an end-use in and of themselves. Such tools are often, though not always, attached to larger machines such as injection molding machines that are more durable and versatile. Such tools also are often, though not always, of predictable life before normal wear and tear require maintenance, repair, or replacement.

A general problem with tooling is tracking the location and usage of such tooling in order that proper schedules for inspection, maintenance, repair or replacement can be maintained. For purposes herein, inspection, maintenance, repair and/or replacement and similar operations shall be summarized as “maintenance”. In addition to scheduled maintenance, some tools wear differently depending upon their specific use or the specific operating conditions to which they are subjected. For instance, wear upon molds and dies used in injection molding may vary greatly depending upon temperature, injection material used, pressure, and similar operating conditions.

Even when tooling is owned and maintained in one location, it is often difficult to track and monitor usage of a particular item of tooling. For instance, a manufacturing operation may have many identical tools, and the actual usage and operating conditions experienced by one particular tool may be difficult to track among the many similar or identical tools. These and similar tracking problems become greatly exacerbated for a tool owner when the tool is used and operated by a party other than the tool owner. Use by third parties is particularly common in contract manufacturing, where a customer of a manufacturing shop often owns tools that are unique to itself. Whether such tools are designed by the customer or by the manufacturing shop, customers generally prefer to own their tooling for cost, tax, and control reasons. Ownership lowers cost since the manufacturing shop need not carry the tool on its books and charge overhead. Ownership lowers taxes by enabling the owner to take depreciation. Ownership is believed to improve control since if a customer owns an asset, the customer reasonably believes that it can direct the vendor to only use the tool for the customer.

As described above, scheduling maintenance of tooling is sometimes a difficult task even when the subject tooling remains in the possession of an owner operator. Where the tooling is in the control of a third party such as a contract manufacturer, the parties may agree by contract or otherwise how the tooling will be used and maintained, yet tracking whether such agreements are in fact followed is often difficult or impossible. Many industrial customers have experienced much higher tool replacement expense than expected, and the industrial customer is forced to accept such replacement costs without knowing whether the tooling was maintained properly or even whether it was used in an unauthorized fashion for a customer other than the tool owner. Understanding the causes of tooling failure or excessive wear are often difficult to determine after-the-fact since tool failure and wear can have many causes in addition to poor maintenance or excessive usage. Such additional reasons for tool failure or wear include, without limitation, poor tool design and materials, unexpected operating conditions, etc. Since much industrial tooling is very expensive, unexpected replacement costs can add greatly to a customers cost base over expected amounts.

For the above reasons, it would be desirable to have an apparatus and method for tracking tooling location, usage, operating conditions, and other parameters affecting the life and maintenance of tooling.

One embodiment of the invention is a process for monitoring usage of tooling, comprising: fixedly coupling a memory device to an item of tooling; storing data in the memory device pertaining to the item of tooling; and reading data from the memory device.

### BRIEF DESCRIPTION OF THE DRAWINGS

FIG. 1 is a schematic drawing of an injection mold system embodiment of the present invention wherein the injection mold system comprises a memory device and a linked logic device.

FIG. 2 a schematic drawing of a wireless memory device embodiment of the present invention.

### DETAILED DESCRIPTION

For a general understanding of the present invention, reference is made to the drawings. In the drawings, like reference numerals have been used throughout to designate identical elements.

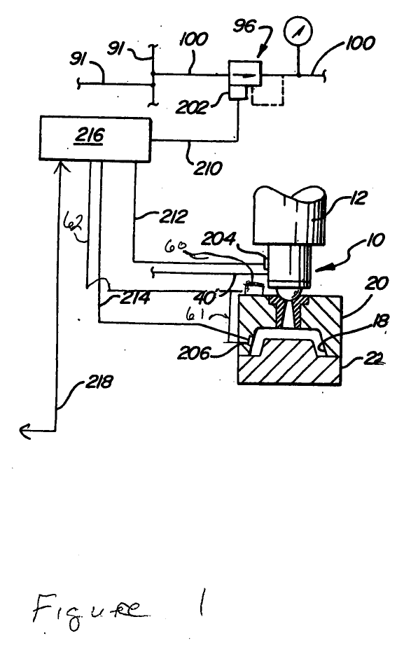

An exemplary tool with which the advantages of the present invention will be described is an injection mold. For purposes of describing typical injection mold apparatus and procedures, U.S. Pat. No. 5,118,455, issued to Loren, is hereby incorporated in its entirety herein. FIG. 1 is adapted from FIG. 1B of the '455 patent. Injection mold 50 is comprised of mold halves 20 and 22. Mold 50 and its components comprise the tooling that is subject to wear and tear during usage. Cavity 18 defines the shape of the part to be formed. Nozzle 10 receives injection resin from injection molding machine 12. The injection molding is gas assisted by gas injected through gas injection conduit 40. Conduit 40 is connected (connection not shown) to nitrogen gas supply members 91 and 100. Gas pressure is regulated by regulator valve 96 which, in turn, is controlled by motor 202. Control of the system is coordinated by programmable logic device 216 based upon inputs from sensors 204 and 206 through leads 204 and 206, respectively. Based upon these inputs, logic device 216 sends control signals through lead 210 to activate motor 202 that controls pressure regulator 96. Logic device 216 also communicates with the rest of the injection system through lead 218. As described in the '455 patent, sensors 204 and 206 are thermocouple temperature sensors. One skilled in the art will understand that sensors 204 and 206 may be selected and configured as any type of sensor, including without limitation, sensors for pressure, temperature, wear, dwell time, etc.

FIG. 1 also shows a memory device 60 fixedly mounted at or near the external surface of mold 50. For purposes of the invention, a particular memory device will be “fixedly coupled” with a tool when fixedly mounted or otherwise dedicated to a particular tool during its use and operation and when decoupling of the memory device from the tool is expected to occur only at unusual events such as during maintenance, replacement, or repair. Memory device 60 will typically be non-volatile in order not to require a power source. However, a memory device coupled with a battery or other power source may have a number of advantages that will be described below. When coupled with a power source, memory device 60 may comprise a volatile memory device. If non-volatile memory is used, such non-volatile memory may be a simple flash memory device, an EEPROM, or any other non-volatile memory storage device. For descriptive purposes, memory device 60 will hereinafter be described as an EEPROM. Lead 62 provides data to EEPROM 60 from logic device 216. Such a link enables indirect communication with sensor 206 which is embedded inside mold 50. Alternatively, lead 61 provides data to EEPROM 60 directly from sensor 206. The general purpose of EEPROM 60 is to store information that enables a tool owner to track usage of mold 50 in accordance with any number of parameters selected for gathering and storing in EEPROM 60. EEPROM 60 may also be used to carry identification data concerning mold 50 itself. Such information is useful for identification of which mold to select for a particular job and may also be coupled with logic in logic device 216 to ensure that the correct mold is used for the job being performed. One skilled in the art will understand that EEPROM 60 can be located anywhere on or in mold 50. Because of the high temperatures experienced by mold 50, EEPROM 60 may be thermally insulated from the main body of mold 50 and may comprise a version of memory that is designed to maintain performance under high heat conditions.

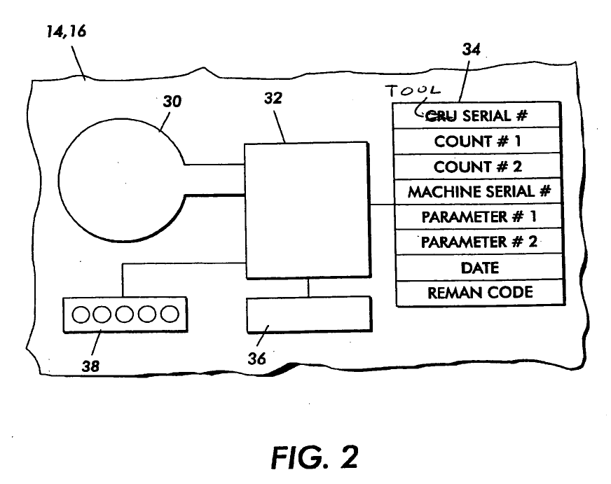

As stated above, EEPROM 60 can be any form of memory and is most typically non-volatile memory. FIG. 2, adapted from U.S. Pat. No. 6,351,621, provides a schematic diagram of a radio frequency wireless EEPROM that may be adapted for embodiments of the invention that lack leads connecting memory device 60 with an external CPU such as logic device 216 coupled through lead 62 with EEPROM 60. Many examples of EEPROMs with features and capabilities that may be adapted for the present invention are set forth in U.S. Pat. No. 6,351,621 (wireless memory chips); U.S. Pat. No. 5,289,210 (memory chip encoded with identity and performance characteristics of the coupled print cartridge); U.S. Pat. No. 5,283,613 (an event counter, including a decrement only counter); U.S. Pat. No. 5,049,898 (encoded identity and performance characteristics of coupled printhead and a “gas gauge” reflecting use of cartridge); and U.S. Pat. No. 4,961,088 (identity information and event counter). Each of these references is hereby incorporated herein in their entirety.

Embodiments of the invention that contain direct links between EEPROM 60 and an external CPU can provide features, uses, and capabilities analogous to all of the features, uses, and capabilities described in the above incorporated references. EEPROM 60 may encode, for instance, the serial number, owner, and other identity indicia of the tool. When installed, logic device 216 can inquire to ensure that the correct tooling is installed for the correct part for the correct customer. A lock-out feature can be programmed such that no operations can occur if the installed tooling doesn't match the correct identity information. The EEPROM can also be encoded with information to aid in its maintenance and refurbishment. For instance, the original tool maker can be encoded as well as the date and servicer's identity for each time (or at least the last time) the tooling has been maintained or repaired. Operating parameters such as optimal dwell time, cycle time, temperature, pressure, etc. can be encoded for reference by operators or for automated programming by logic device 216. In one embodiment, logic device 216 is a controller of the machine processes and utilizes operating parameter information stored in the memory device for controlling the operation being performed with the tool. In addition, logic device 216 can encode useful operating environment information onto EEPROM 60 such as actual dwell time, cycle time, temperature, pressure, cycle count, measured wear, etc. By encoding such actual data, including maintenance information matched to cycle count or other indicia of wear, tooling owners can better determine whether their tooling has been properly used or, instead, has been abused. Simply by matching encoded cycle count against actual parts delivered by a vendor, a tooling owner can obtain information concerning a vendor's efficiency, error rates, or even whether the tooling has been put to unauthorized use. Additionally, if tooling performance is known to change over the life of the tooling because of wear, changes in temperature rise rates, etc, then logic device 216 can use operating life data stored on EEPROM 60 to alter operating parameters of injection machine 12 or whatever other type of system is being used with the subject tooling. Much additional static or operational information can be stored on EEPROM 60, and the operators and logic devices can use such information for many purposes in addition to those listed above.

Yet additional benefits can be achieved if logic device 216 is connected with communication means that permit communication outside injection molding machine 12 and its components. Such a communication means is indicated by lead 218 showing data flow to and from logic device 216. For instance, a web-based communication system can help an owner track the worldwide location and use of all of its enabled tooling. Such tracking would enable better inventory control, replacement scheduling, capacity prediction and control, and permit a tool owner to participate directly in programs for maintenance, repair, and replacement. Even communication within a manufacturing facility to central data bases would enable a shop to better track usage and inventory of tooling in its possession.

Where EEPROM 60 is a wireless chip as shown in FIG. 2, many or all of the features and benefits described in the preceding paragraph can be obtained if logic device 216 is equipped with an antenna and receiver through which to communicate with EEPROM 60. Even if logic device 216 cannot receive data directly from EEPROM 60, an ability to send data to EEPROM 60 through leads or through an antenna permit all of the information described above to be transmitted to and stored in EEPROM 60. A hand held or other portable scanner can then download such information from EEPROM 60 when desired. Many but not all of the benefits described above can accordingly be achieved. Where EEPROM 60 cannot communicate with an external logic device, functionality may be limited but still of great value. For instance, identification information and information concerning tooling manufacturer, maintenance and repair provider, dates of maintenance and repair, etc, can all be stored on EEPROM 60 through direct programming or through its radio receiver. When connected by radio frequency or by leads to sensors such as sensor 206, data from such sensors can be recorded on EEPROM 60. By counting the number of temperature cycles or similar operating cycles, an effective usage count can be stored on EEPROM 60 for future retrieval. Where power is available to EEPROM 60, a simple timing device can be encoded into EEPROM 60, and cycle and dwell time and similar information can be obtained and stored for future retrieval. EEPROM 60 can be encoded with various other software to permit its own manipulation, interpretation, and storage of information received from sensors such as sensor 206. Once information stored on EEPROM 60 is downloaded directly to a communication conduit or through indirect means such as a handheld communication device that can transfer data into a communication conduit, then such information can be stored and used locally or transmitted anywhere desired. For instance, a tooling owner located remotely from a vendor could require periodic inventory and information updates concerning its tooling in the vendor's possession, and personnel of the vendor (or of the tooling owner) could walk through the shop with a handheld radio receiver to recover data from all wireless EEPROMS within transmitting distance.

Of course, wireless memory devices are not necessary to obtain many of the advantages described above. As described above in relation to FIG. 2, communication between a memory device and a logic device enables the described features without a wireless capability. Even without such real-time communication with a logic device, an EEPROM can store all of the data described above in relation to wireless devices. The only difference is that retrieval of information from the EEPROM would presumably be through a device that would plug into a communication port when communication to or from the EEPROM is desired. Such a communication device could be handheld or could be part of a larger device presumably used when tooling is manufactured, maintained, or repaired.

An exemplary use of embodiments of the invention is in relation to the manufacture of print cartridges for electrostatographic printers. Such print cartridges often sell for attractive margins over manufacturing cost. Tooling used in the manufacture of print cartridges includes, without limitation, injection molds for plastic parts, fixtures for holding and positioning parts during assembly, cutting tools and fixtures for cutting drums, rolls, etc, and a host of other tools. Because print cartridges are often mass produced, many copies of tooling are often made and tracking the various tooling is often difficult. Such problems are compounded when specialized components are made or assembled by third party vendors using specially designed tooling owned by the system designer of the printer. Such tooling in the aggregate typically constitute huge investments. Proper use and maintenance is accordingly important. Additionally, because margins on the print cartridge are often very attractive, system designers would benefit from an ability to ensure that unscrupulous vendors do not use tooling for unauthorized purposes. For all of the above reasons, system designers of print cartridges and many other system owners would greatly benefit from embodiments of the invention that better permit a tool owner to track and control location, usage, operating conditions, maintenance, repair, and replacement of tooling. It is believed that memory devices coupled with tooling as described herein offer an improved solution that can achieve the enumerated benefits.

While particular embodiments have been described, alternatives, modifications, variations, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

1. A process for monitoring usage of tooling, comprising:
fixedly coupling a memory device to an item of tooling;
storing data in the memory device pertaining to the item of tooling, the stored data including at least identification data for the item of tooling;
reading data from the memory device;
sensing at least one parameter of an operating environment with at least one sensor; and
storing the at least one parameter in the memory device.

2. (canceled)

3. The process of claim 1, further comprising, before using the tooling, confirming that the identification data stored in the memory device matches identity information for a planned use of the item of tooling.

4. The process of claim 3, further comprising, when the identification information does not match, aborting use of the item of tooling.

5. (canceled)

6. The process of claim 1, wherein the memory device is non-volatile memory.

7. The process of claim 1, wherein the memory device is an erasable programmable read only memory device.

8. The process of claim 1, further comprising communicating with the memory device using radio frequencies.

9. The process of claim 1, further comprising counting operating cycles of the item of tooling.

10. The process of claim 9, wherein a counting comprises decrementing an amount stored in the memory device for each operating cycle experienced by the item of tooling.

11. The process of claim 1, further comprising:
determining, with a logic device, from the sensed parameter that an operating cycle has occurred; and
counting the operating cycle in data stored in the memory device.

12. The process of claim 1, wherein the stored data comprises information pertaining to maintenance of the item of tooling.

13. The process of claim 1, wherein the stored data comprises information relating to at least one optimal operating environment parameter for the item of tooling.

14. The process of claim 13, further comprising:
communicating the stored optimal operating environment parameter data to a system controller; and
using, by the controller, the communicated optimal operating environment parameter data in directing at least one actual operating parameter.

15. The process of claim 1, wherein the stored data comprises data relating to actual operating environment, parameters for the item of tooling.

16. The process of claim 1, further comprising:
communicating at least a portion of the stored data to a logic device separate from the memory device; and
sending the stored data from the logic device to outside the operating environment of the item of tooling.

17. The process of claim 16, wherein sending comprises web-based communications.

18. The process of claim 1, further comprising determining a cycle time parameter and storing the parameter in the memory device.

19. The process of claim 1, wherein an apparatus that uses the item of tooling comprises a communication port and wherein reading data comprises using a device plugged into the communication port.

20. A process for monitoring usage of tooling, comprising:
fixedly coupling a memory device to an item of tooling;
storing data in the memory device pertaining to the item of tooling, the stored data including at least identification data for the item of tooling,
reading data from the memory device;
sensing at least one parameter of an operating environment with at least one sensor; and
storing the at least one parameter in the memory device,
wherein the item of tooling is specialized for the manufacture of at least one component of an electrostatographic print cartridge.

21. The process of claim 1, wherein reading data commences at the request of a tooling owner located remotely from a location of an apparatus that uses the item of tooling.

22. The process of claim 1, wherein reading further comprises using a portable device that receives radio signals emitted form the memory device.
